(19) United States
(12) Patent Application Publication
(10) Pub. No.: US 2006/0083305 A1
(43) Pub. Date: Apr. 20, 2006

(54) Distributed motion detection event processing

(76) Inventors: James Dougherty, Morgan Hill, CA (US); Yaxiong Zhou, San Jose, CA (US); Sheng Qu, San Jose, CA (US); Yong Wang, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/158,368

(22) Filed: Jun. 20, 2005

Related U.S. Application Data
(60) Provisional application No. 60/619,555, filed on Oct. 15, 2004.
(60) Provisional application No. 60/635,114, filed on Dec. 10, 2004.

(51) Int. Cl. H04N 7/12; H04N 11/04; H04B 1/66; H04N 11/02

(52) U.S. Cl. 375/240.12; 375/240.24

(57) ABSTRACT

A motion detection system can detect motion at a macroblock level of granularity and take an action based on the detection of motion or an event in a specified region of interest. The system comprises an ASIC capable of detecting an event in a macroblock of a frame of a video sequence, and an eventing engine for, responsive to the detection of the event by the ASIC, performing an action. Such a system can be configured by a user who provides an input specifying a region of interest on which motion detection should be performed by the motion detection system and a threshold value for determining whether or not motion has occurred in the region of interest.

### CROSS-REFERENCE TO RELATED APPLICATIONS

This patent claims the benefit of U.S. Provisional Patent Application 60/619,555 entitled “Distributed Motion Detection Event Processing” and filed on Oct. 15, 2004, which is hereby incorporated by reference in its entirety; this patent claims the benefit of U.S. Provisional Patent Application 60/568,892 entitled “Video Processing System and Method” and filed on May 7, 2004, which is hereby incorporated by reference in its entirety; this patent claims the benefit of U.S. Provisional Patent Application 60/635,114 entitled “Video Processing System and Method” and filed on Dec. 10, 2004, which is hereby incorporated by reference in its entirety.

### BACKGROUND

1. Field of the Invention

This invention relates to motion detection and more specifically to an automated, hardware-based motion detection system capable of taking specific actions in response to detection of an event.

2. Background of the Invention

A well-known problem in the surveillance arts is the problem of false positives. Although the declining cost of processing power has allowed for the evolution of large systems capable of handing tremendous amounts of video and audio data, human intervention is still needed to determine whether events detected really are significant and warrant further action. Even after an event is detected, current systems require the intervention of security or other personnel to make decisions and take actions such as notifying authorities, securing the affected area, and activating alarms. Current computerized motion detection systems are implemented in software and consume considerable processing resources, imposing a limit on the resolution and quality of detection.

What is needed is a way to improve the quality of motion detection and automate the taking of triggered actions when an event is detected.

### SUMMARY OF THE INVENTION

In an embodiment of the present invention, there is a motion detection engine. The engine comprises an application specific integrated circuit (ASIC) including firmware for performing macroblock-level motion detection on a video sequence. By implementing the motion detection through hardware and firmware, the invention beneficially allows for quick and efficient processing, allowing for motion detection at a highly granular, macroblock level.

In an embodiment of the present invention, a motion detection system comprises an ASIC capable of detecting motion in a macroblock of a frame of a video sequence. It also includes an eventing engine communicatively coupled to the ASIC, for, responsive to the detection of motion by the ASIC, performing an action. In an embodiment, the action comprises a communication action, a storage action, a reporting action, a device activation action, an additional motion detection/processing action, a multicast/parallel processing action, or a system configuration/application control action. In an embodiment, the eventing engine is implemented in firmware, facilitating efficient processing at a high resolution.

### BRIEF DESCRIPTION OF THE DRAWINGS

The accompanying drawings illustrate embodiments and further features of the invention and, together with the description, serve to explain the principles of the present invention.

FIG. 1 is depicts the system architecture of a motion detection system in accordance with an embodiment of the invention.

FIG. 2 depicts the firmware/software environment of a motion detection system in accordance with an embodiment of the invention.

FIG. 3 depicts a user interface for designating inputs for a motion detection system in accordance with an embodiment of the invention.

FIG. 4 depicts a set of regions of interest (ROIs) analyzed in accordance with an embodiment of the invention.

### DETAILED DESCRIPTION OF THE PREFERRED EMBODIMENTS

The present invention is now described more fully with reference to the accompanying Figures, in which several embodiments of the invention are shown. The present invention may be embodied in many different forms and should not be construed as limited to the embodiments set forth herein. Rather these embodiments are provided so that this disclosure will be complete and will fully convey the invention to those skilled in the art.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention. For example, the present invention will now be described in the context and with reference to MPEG compression, in particular MPEG 4. Still more particularly, the present invention will be described with reference to blocks of 16×16 pixels. However, those skilled in the art will recognize that the principles of the present invention are applicable to various other compression methods, and blocks of various sizes.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

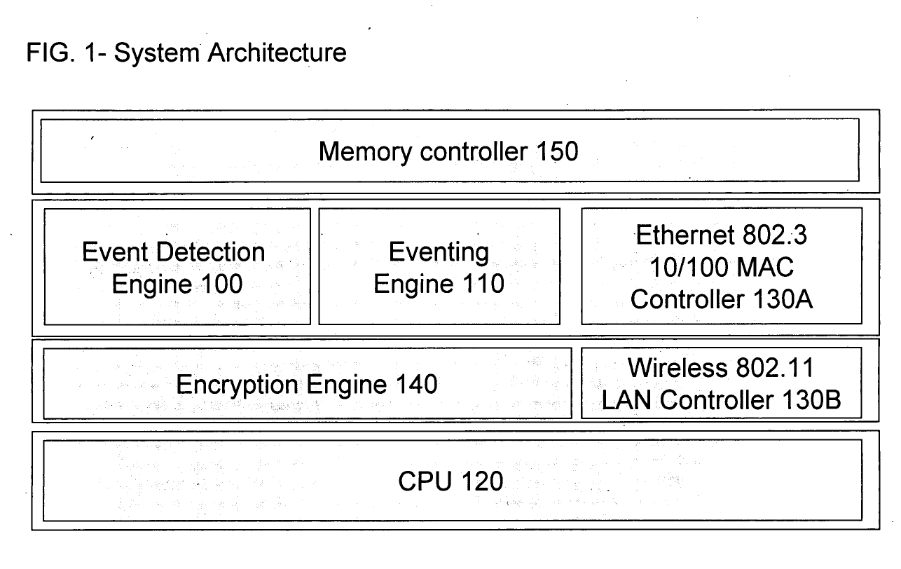

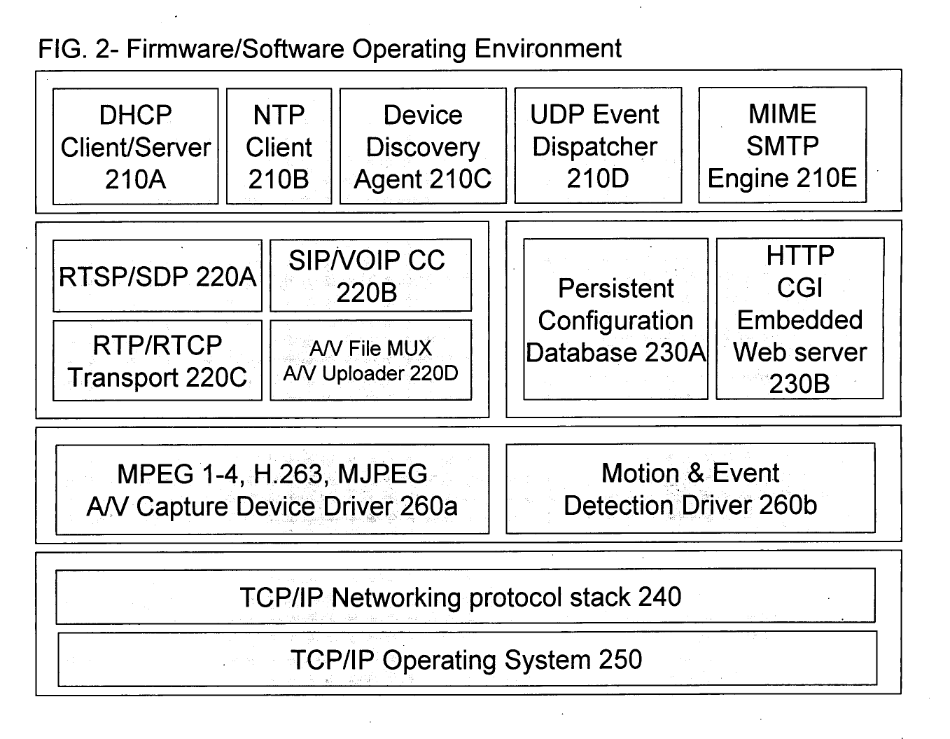

The algorithms and modules presented herein are not inherently related to any particular computer or other apparatus. Various general-purpose systems may be used with programs in accordance with the teachings herein, or it may prove convenient to construct more specialized apparatuses to perform the required method steps. The required structure for a variety of these systems will appear from the description below. In addition, the present invention is not described with reference to any particular programming language. It will be appreciated that a variety of programming languages may be used to implement the teachings of the invention as described herein. Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment. Exemplary system and firmware/hardware operating environments are shown in FIGS. 1 and 2. However, it is not necessary for every embodiment of the invention to include all of the elements depicted. Furthermore, it is not necessary for the elements to be grouped as shown; the elements can be hosted by other entities or in sub-modules of the elements may stand-alone or together. Likewise, as other elements and sub-elements are described throughout the invention, it should be understood that various embodiments of the invention may exclude elements and sub-elements described, that the elements and sub-elements may be hosted in configurations other than those shown, and that elements and sub-elements, even within an element, may be hosted in different locations or by different entities than those shown.

FIG. 1 shows the architecture of a motion detection system 105 including a motion detection engine 100, eventing engine 110, processor 120, encryption engine 140, memory controller 150, and various network interfaces 130. The motion detection engine 100 can receive a video stream from various sources, for instance nodes on a surveillance network, cameras, or a TV system. The motion detection engine 100 processes the stream, calculating various parameters that are used to detect motion. A motion detection algorithm is applied to the parameters to determine whether or not there has been motion. Assuming motion is detected, the engine 100 passes the compressed stream and motion detection parameters to the eventing engine 110 for further processing. Further processing is carried out on the CPU 120 by the eventing engine 110, and the resulting output is provided to a destination over a network interface 130. As is known in the art, computers are adapted to execute computer program modules for providing functionality described herein. As used herein, the term “module” can refer to computer program logic for providing the specified functionality. A module can be implemented in hardware, firmware, and/or software. Preferably, a module is stored on a computer storage device, loaded into memory, and executed by a computer processor.

The motion detection engine 100 processes an incoming video stream or video/audio streams and detects motion on the stream. As used throughout this specification the terms “video” and “audio/video” are used interchangeably and encompass video, video/audio, and other data including video content of any of a variety of existing and emerging multimedia video formats. The motion detection engine 100 processes an incoming video and may perform a variety of functions besides motion detection including encoding and compression. This processing may be carried out according to a known protocol such as associated with a Moving Picture Experts Group (MPEG), H.263, H.264, or other video or video encoding standard such as is defined by ISO/IEC 14496-2:2001 and described in various editions of the ISO/IEC publication “Coding of Audio-Visual Objects-Part 2, Visual,” which are hereby incorporated by reference in its entirety.

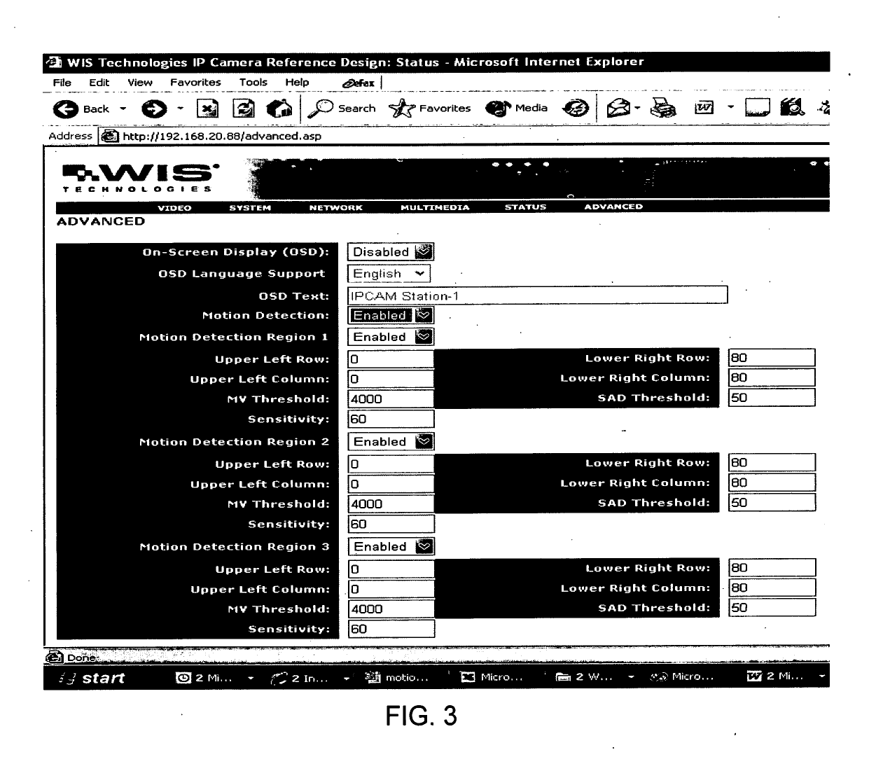

The motion can be detected in one or more specific areas of the video stream that correspond to pre-designated regions of interest (ROI). During the setup phase of the system 105, specific targeted portions of the video frames are designated for motion detection. The user can use a browser-based graphical user interface (GUI) such as the interface of FIG. 3 to specify image regions that comprise the ROI. In an embodiment, the ROI is defined in terms of a cluster of macroblocks, in accordance with various MPEG video standards. The macroblock comprises a 16×16 pixel square. In other embodiments, however, it may comprise an 8×8 pixel square, a 3-D block implemented in two polarized video stream, or a block of other dimensions. In a surveillance application, a surveillance camera captures images from a company foyer and reception area. A ROI could be designated for the area representing the door in order to detect intruders entering after hours. An additional ROI may be specified to detect movement specifically of the doorknob.

In order to accomplish motion detection at a macroblock level of granularity, in an embodiment, the motion detection engine 100 comprises a system-on-chip ASIC containing firmware for encoding and compresses a video stream during the course of motion detection. One such ASIC is the ASIC GO7007SB Single Chip Streaming Media Encoder chip made by WIS Technologies of San Jose, Calif., which encodes incoming video streams according to MPEG video formats. In other embodiments, however, the motion detection engine 100 may be implemented through a combination of hardware and software or firmware. For the designated ROI or ROIs, the eventing engine 110 calculates various parameters to detect motion. In an embodiment, these parameters include: (1) the sum of absolute differences (SAD), and (2) motion vectors (MVs) per macroblocks. The SAD for a given macroblock in an ROI is the sum of the differences between all of the pixels within macroblock of a current picture frame as compared to the best match macroblock size region in a reference picture and reflects the level of similarity between the compared blocks. The SAD may be defined as below:

$$SAD ( {d}_{x} , {d}_{y} ) = {\sum }_{i} {\sum }_{j} \vert f ( i , j ) - g ( i + {d}_{x} , j + {d}_{y} ) \vert$$

where
f(i,j) is the pixel in the macro-block being compressed
g(i,j) is the pixel in reference macro-block
(dₓ,d_{y}) is the search location vector
   MV is defined as:
   MV=SQRT(dₓˆ2+d_{y}ˆ2)
   (SQRT stands for square root).
   In an embodiment, each macroblock is downsized, from 16×16 to 4×4 for instance, and the SAD is computed based on this information.

The SAD and MV values are used to detect motion. A very high SAD value means very low similarity, meaning the current macroblock is a result of video content change. This case is treated as motion. Another case of motion is that we have very small SAD value, but large MV value. This means that the current macroblock is result of object movement. To detect motion, in one embodiment, the SAD for each macroblock is compared to a pre-defined SAD motion threshold to determine whether or not the macroblock is a motion macroblock or not. Alternatively or in addition, a MV value for each macroblock is compared to a MV motion threshold to make the same determination. The current macroblock is declared to be a motion macroblock when either the SAD or MV value is greater than the corresponding threshold or only if both of them are greater than the thresholds.

The sum of motion macroblocks (SMM) within a given ROI, as determined by either SAD and/or MV method, is then compared against a value based on the total number of macroblocks (MB_TOTAL) within the ROI and a sensitivity threshold (SENSITIVITY) to determine whether motion has been detected within the ROI as per the algorithm below:
If (SMM>MB_TOTAL*SENSITIVITY)

Then, declare the ROI as motion ROI.

Otherwise,

declare it as non-motion ROI.

A user can specify the two motion thresholds, as well as the sensitivity threshold for each ROI, to be used in the algorithm.

Block motion estimation and compensation (BMEC) have been widely used in current video coding standards (MPEG and H.26x) to exploit temporal redundancy. SAD and MV used by the motion detection algorithm are also used by the motion estimation algorithm. This means that the calculation of these parameters is accomplished by the video compression engine during the Motion Estimation stage of video stream compression. Beneficially, this approach leverages the processing and memory resources consumed during video encoding and applies them to motion detection. Under this implementation, no dedicated hardware is necessary to implement the motion detection and the computation is simple. For each macroblock only two comparison, one addition and two multiplication calculations are needed. There are several possible firmware-based implementations, two are described below.

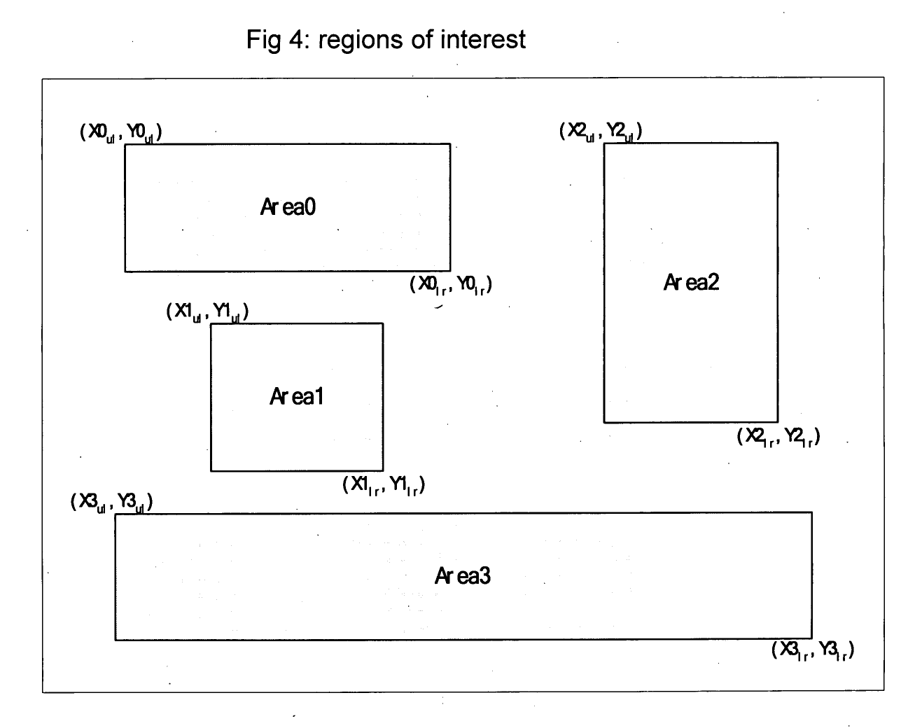

In one embodiment, there are four rectangular object areas, or ROIs, each defined by the opposing corner coordinates (Area 0 defined by X0ul,Y0ul, and X0lr, Y0lr, for instance, and so on.) These ROIs are shown in FIG. 4. The following variables are defined:

Variables:

unsigned char x,y; coordinates of current macro block, saved in local register
unsigned short SAD; SAD of current macro block, saved in local register
unsigned char MVx,MVy; motion vector of current macro block, saved in local register
unsigned short SADThreshold; SAD threshold, saved in memory
unsigned char MVxThreshold; MVyThreshold; motion vector threshold, saved in memory
unsigned char X0ul,Y0ul; up left coordinates of object area 0, saved in memory.
unsigned char X0lr,Y0lr; low right coordinates of object area 0, saved in memory.
unsigned char X1ul,Y1ul; up left coordinates of object area 1, saved in memory.
unsigned char X1lr,Y1lr; low right coordinates of object area 1, saved in memory.
unsigned char X2ul,Y2ul; up left coordinates of object area 2, saved in memory.
unsigned char X2lr,Y2lr; low right coordinates of object area 2, saved in memory.
unsigned char X3ul,Y3ul; up left coordinates of object area 3, saved in memory.
unsigned char X3lr,Y3lr; low right coordinates of object area 3, saved in memory.
unsigned short movingMBCount; number of moving macro blocks, saved in memory.
unsigned short movingMBCountThreshold; threshold of moving macro blocks, saved in memory.

When encoding each macroblock with pixel coordinate of (x,y) of its upper-left corner pixel, the firmware specifies:

```
if (SAD > SAD_Threshold | MV >MV_threshold)) {
if ((x > X0ul & x < X0lr & y > Y0ul & y < Y0lr)
  movingMBCount[roi_0]++;
else if (x > X1ul & x < X1lr & y > Y1ul & y < Y1lr)
  movingMBCount[roi_1]++;
else if(x > X2ul & x < X2lr & y > Y2ul & y < Y2lr)
  movingMBCount[roi_2]++;
else if (x > X3ul & x < X3lr & y > Y3ul & y < Y3lr))
  movingMBCount[roi_3]++;
}
```

After the whole frame is encoded, the firmware specifies:

for( roi=0; roi<3; roi++){
if (movingMBCount[roi] > movingMBCountThreshold[roi])
send interrupt to external host;
movingMBCount[roi] = 0;
}

Another exemplary approach is more memory intensive but consumes less processing resources. Under this approach, the 8 coordinates are converted into a bitmap. This functionality can be provided, for instance, by a developer's kit. The bitmap is saved into memory before encoding starts. 2 bits are used for each macroblock to indicate if the macroblock is located in one of the 4 object areas. In an embodiment, 338 bytes of memory are required to save the bitmap for a D1 (720×480) size frame. Variables that could be used in this approach include:
unsigned short SAD; SAD of current macro block, saved in local register
unsigned char MVx,MVy; motion vector of current macro block, saved in local register
unsigned short SADThreshold; SAD threshold, saved in memory
unsigned char MVxThreshold; MVyThreshold; motion vector threshold, saved in memory
unsigned short MBCount; macro block counter, saved in memory
unsigned short bitmap[102]; bitmap, saved in memory.
unsigned short bitmapBuff; 16-bit bit map buffer for shifting, saved in memory.
unsigned short movingMBCount; number of moving macro blocks, saved in memory.
unsigned short movingMBCountThreshold; threshold of moving macro blocks, saved in memory
MAX_MB_NUM: number of macroblocks in a frame, saved in memory.

When encoding each macro block, the firmware specifies:

```
  While(MBCount < MAX_MB_NUM){
    roi = (bitmap[MBCount/4] ) >> (8− ((MBCount % 4)+1)*2);
    (SAD > SADThreshold[roi] | MV > MVThreshold[roi] ) {
    movingMBCount[roi]++;
    }
    MBCount++;
}
```

After the whole frame is encoded, the firmware specifies:

```
for(roi=0; roi<4; roi++) {
  if (movingMBCount [roi]> movingMBCountThreshold[roi]) {
    send interrupt to external host;
    }
    movingMBCount[roi] = 0;
}
MBcount = 0;
```

Assuming that motion in a region is detected, an action may be taken by the eventing engine 110. The eventing engine 110 is preferably implemented in firmware and can take any of a number of actions on the CPU 120. Categories of possible actions include 1) communications, 2) storage, 3) reporting, 4) device activation, 5) additional motion detection, 6) multicast/parallel processing, and 7) system configuration/application control, each of which is explored more fully with reference to FIG. 2. The triggering motion or events as well as the resulting actions and their schedule may be specified by a user using an interface such as that shown in FIG. 3. The resulting action may be carried out locally, or over a network connection 130. Data can be sent over an Ethernet connection using the Ethernet 802.3 10/100 MAC controller 130a, while the wireless LAN controller 130b controls wireless data transfer in accordance with an IEEE 802.11 standard. Data sent wirelessly is first encrypted using an encryption engine 140, which may be configured to generate encryption keys. Resources for the various processing tasks are allocated and managed by the memory controller 150.

In an embodiment, the eventing engine 110 operates in the software/firmware operating environment shown in FIG. 2. The environment includes an operating system (OS) 250, software and device drivers 260, and various modules 210-240 for conforming to various communications, data, and transport protocols. Preferably, the OS 250 is an embedded OS, and the processor of the motion detection system comprises an integrated processor. The operating system can comprise any existing or emerging operating system such as a Windows, Apple, Linux, Sun or other proprietary or open source operating system. A device driver 260a acts as an interface between the motion detection system 105 and various video capture sources. A motion and event detection driver 260b interfaces between the eventing and motion detection engines and the general operations of the motion detection system 105. The drivers and any needed interfaces may be provided through a standard developer's kit.

When motion is detected, one or more of the modules 210-240 is used to carry out the various actions described below, in accordance with, for instance, dynamic host configuration protocol (DHCP) 210a, user datagram protocol (UDP) 210d, Simple Mail Transfer Protocol (SMTP) 210e, web 230b, Session Initiation Protocol (SIP) 220b, Real-Time Transport Protocol (RTP) 220c, Voice over IP (220b) or other protocols. Processed files may also be multiplexed and uploaded using the A/V module 220d, and provided to a web server 230b. As described above, although the elements of FIG. 2 are shown grouped in a particular manner, one of skill in the art would know the modules may resides in different or the same locations than as shown, and may be grouped in any number of ways.

Communications

Upon detection of an event by the motion detection module, the eventing engine 110 can initiate an alert or communication with an entity or entities simultaneously. The eventing engine 110 can generate for instance an alert to be sent by email, pager, SMS, fax, PSTN, VoIP, internet phone connection (such as provided by Iconnect.com or skype.com), instant message, or other media to a location provided by a user or accessible in another way. The alert can simply notify the recipient of the detection of an event, or may comprise a compressed audio or video clip, or data, a transcription, images, live feed, or link to a web or other location where the content can be accessed. The video or audio clip can comprise Realtime MPEG4 compressed content, sent realtime, over an IP network. In one embodiment, an email, encapsulated in a RTP or an IETF standard payload encapsulation format is sent with embedded Dynamic HTML content that provides a video in the message. Selection of the email will result in a real-time showing of the video to a user.

In an embodiment, the eventing engine 110 sends an email with that includes a link embedded into a text description to a secure website. The link includes the necessary information to query a repository to which motion detection content has been stored which field information is provided to a web server. When the user activates the link in the email, a browser application is invoked and contacts the web server, passing in the parameters that identify the content. Or, activation of the link leads to execution of an Audio/Video receiver application to receive Compressed MPEG1,2,4 video streams, and Compressed MPEG1, L2, ALaw/uLaw, audio streams, in realtime. The web server creates a web page from which the content can be viewed, downloaded, or otherwise accessed. In an embodiment, the content is devised by a WIS chip and is capable of being transmitted at a rate of >15 FPS.

The communication may comprise metadata about the event detected including its location, the time of the event, the resources available to mobilize a response to the event. In an embodiment, the eventing engine 110 accesses various systems to find out their status and uses that to develop a list of options for the user, which it sends to the user in the form of an email, automatically generated phone message, or other communication. The communication may solicit an election by the user of an additional action to take—for instance to broadcast the information to a security or law enforcement authority. When the user selects this response, by pushing a touch tone or other mechanism, the action is automatically taken, by the eventing engine 110 or another implementing system.

The eventing engine 110 may chose among different technology options including session initiation protocol (SIP) technology for event notification, telephony, presence, and/or instant messaging. It may also tailor its output intelligently depending on network characteristics such as the bandwidth or system limitations associated with various nodes of the network over which the communication is sent.

Storage

The eventing engine 110 may also capture events and store them to a repository coupled to the motion detection system. The repository could comprise one or more remote servers stored on a network and/or any memory including a portable storage medium (not shown) such as a tape, disk, flash memory, or smart drive, CD-ROM, DVD, or other magnetic, optical, temporary computer, or semiconductor memory. Each event portion could be profiled with metadata about the event including the time, date, location, and other information, and stored appropriately. In an embodiment, a single frame or short clip of the event is chosen as a visual or audio record that can be quickly searched and help the user access relevant events. In an embodiment, the eventing engine 110 keeps a log of all the events that are stored in the repository and creates a searchable index by which the events stored in the repository can be accessed. At regular intervals the repository may be purged unless otherwise indicated.

Reporting

The eventing engine 110 can also prepare reports of events that occur over time. For instance, the eventing engine 110 may scan video clips stored in repository and generate a daily, weekly, or other log of events. The eventing engine 110 may also track certain events—the first and last occurrences of a visitor through the front door of a store, for instance—and generate a report that tracks this information automatically for a user. The user can predefine events of significance, time periods, and output options in order to automatically create reports on a regular interval, or can use an interface to specify the generation of a specific report depending on the event. The report can contain information both about the event and the action or actions taken in response to the event. For instance, if an alert notified a user of an event, and the user in turn activated a multicast alert and extra security measures, the report could record that this took place and include that in the report.

The report could be output in any of a variety of forms—it could be sent by email, posted to a server or website, printed to a designated printer, used to generate a voicemail which is automatically provided to a number of phone numbers using a autodialer system, or any of a variety of embodiments.

Additional Motion Detection/Processing

The eventing engine 110 may also undertake additional motion detection or processing. In one embodiment, the eventing engine 110 could apply pre-designated filters or screens to a sequence where motion has been detected. The detection of a certain number of motion events within a period of time in a designated macroblock, for instance, could be registered as an “activity.” Or, a certain sequence or pattern of events (e.g. motion detected in ROI1, followed in succession by motion in ROI2) may qualify as an “event.” Further actions may be taken based on the detection of such an “event” in the video sequence. In another embodiment, criteria are applied to filter through emails that have been sent including representations of the events, so that the user is apprised on a priority basis of events happening at a certain location. The eventing engine 110 may also undertake additional processing such as using face recognition software or matching facial images against mug shot databases of felons or criminals if a certain event (such as break-in to a high security area) is taken. The eventing engine 110 may also activate the motion detection engine 100 to scan for certain images based on reported events. For instance if a suspicious intruder is detected at one location, the motion detection system 105 may be activated to scan incoming video streams to detect the face, voice, or clothing of the intruder.

Activation of Other Systems

The eventing engine 110 may also be used to activate other systems. This can be accomplished in one embodiment using a Magic Packet, a UDP packet with a specific sequence of bytes. The sequence is a 6 byte synchronization byte sequence (0xFFFFFFFFFFFF), followed by the primary network cards Physical Addresses (MAC address) repeated 16 times in sequence, for a specific machine which is sought to be “woken up.” The technology can remotely wake up a sleeping or powered off PC or other device on a network.

The eventing engine 110 can broadcast unicast or multicast mode signals. For instance, the eventing engine 110 could activate additional cameras or security systems to be turned on, at the beginning of an event or motion taking place. Or, the eventing engine 110 could fire up computers or other devices responsible for determining the appropriate response to an event. The eventing engine 110 can send a Magic Packet to a server, which then sends a RTSP response to the motion detection system, which in turn streams RTP A/V to a server that can render the stream using an AVI processor.

Multicast/Parallel Processing

The eventing engine 110, using Magic Packet, or other technologies, can also activate the simultaneous processing of an event stream. For instance, multiple processors, for conducting face recognition scans, activating additional security devices, determining available security resources, locating personnel on call, could be activated by the eventing module. For instance, if someone left a suitcase in a stairwell, the software would engage any camera within range and alert a worker at the emergency operations center. It would do the same if an individual rushed up to another and dragged him away. A series of cameras could track fleeing criminals, and 911 operators would be able to give police descriptions of suspects.

System Configuration/Application Control

The eventing engine 110 may also configure the system in response to motion or activity patterns, for instance operating in a low power mode when there little or no motion is being detected. In such a state, the engine 110 might cease sending data over the network, logging data only when motion occurs, or occurs at a particular frequency. The engine 10 can switch between a variety of modes, as reflected in changes to various system and other settings.

FIG. 3 depicts a user interface for designating inputs for a motion detection system in accordance with an embodiment of the invention. The user interface shown can be used to designate one or more ROIs. Each ROI is a rectangular region defined by upper-left and lower-right corner coordinates in pixel. Each ROI is programmed with an SAD threshold and an MV threshold and a sensitivity value, which can also be provided by the user through the interface. Using an interface such as FIG. 3, the user can select to enable or disable motion detection. Enabling motion detection may result, for instance, in an interrupt for every frame where the number of macroblocks that have exceeded a threshold has exceeded the user supplied sensitivity setting. The interrupt, in an embodiment, contains a data field that is a bitmap for every ROI that had motion.

The user interface could be used to represent the border coordinates of the image, or to otherwise define the particular space on which motion detection is performed. Although the interface shown allows a user to provide the coordinates of the regions of interest, the region may alternatively be designated using a mouse click over the desired region. Each region is further comprised of several macroblocks; each macroblock belonging to one of the designated regions.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A motion detection engine, the engine comprising an application specific integrated circuit (ASIC) including firmware for performing macroblock-level motion detection on a video sequence.

2. The motion detection engine of claim 1, wherein the ASIC is configured to detect the presence of motion and the amount of motion in a macroblock region of frames of the video sequence.

3. The motion detection engine of claim 2, wherein the ASIC is configured to determine a change in a macroblock of a frame of a video sequence and the macroblock counterpart of a reference frame, and responsive to the change being above a certain threshold, to detect motion in the macroblock.

4. The motion detection engine of claim 1, wherein the ASIC is configured to perform motion detection on a 3-D macroblock.

5. The motion detection engine of claim 1, wherein the ASIC is further configured to perform facial detection on a frame of the video sequence.

6. The motion detection engine of claim 1, wherein the chip is configured to perform motion detection in a macroblock of a frame of the video sequence by simultaneously processing all of the pixels of the macroblock.

7. The motion detection engine of claim 1, wherein the ASIC is configured to perform MPEG compression of the video sequence and to provide motion variables in connection with the compression.

8. The motion detection engine of claim 1, wherein the ASIC is configured to detect motion based on the sum of absolute differences between units of a macroblock of a frame of the video sequence and a macroblock of a reference frame calculated in accordance with the motion estimation stage of MPEG video coding.

9. The motion detection engine of claim 8, wherein the units comprise one of: pixels or bitmaps.

10. A motion detection system, the system comprising:
an ASIC capable of detecting motion in a macroblock of a frame of a video sequence, and
an eventing engine communicatively coupled to the ASIC, for, responsive to the detection of motion by the ASIC, performing an action.

11. The system of claim 10, wherein the ASIC is configured to detect motion responsive to a sensitivity value and a threshold value.

12. The system of claim 10, wherein the eventing engine 110 is configured to register an event responsive to the detection of motion a number of times above a threshold during a period of time.

13. The system of claim 10, wherein the action comprises generating instructions for manipulating a security camera.

14. The system of claim 10, wherein the action comprises streaming the video sequence in real-time to an external server.

15. The system of claim 10, wherein the action comprises one selected from the group comprising: a communication action, a storage action, a reporting action, a device activation action, an additional motion detection/processing action, a multicast/parallel processing action, and a system configuration/application control action.

16. The system of claim 10, wherein the ASIC is capable of detecting the presence of motion and the amount of motion in a macroblock region of frames of the video sequence.

17. The system of claim 10, further comprising a communications interface over which the action can be performed.

18. A method for configuring a motion detection system comprising an ASIC for performing macroblock-addressable motion detection, the method comprising:
receiving an input from a user specifying a region of interest on which motion detection should be performed by the motion detection system; and
receiving a threshold value for defining whether or not motion has occurred in the region of interest.

19. The method of claim 17, wherein the input comprises one of an upper coordinate and lower coordinate, and a selection of a portion of a video frame.

20. The method of claim 17, wherein the threshold value comprises one of a sum of absolute differences threshold value, a motion vector threshold value, and a sensitivity value.

21. The method of claim 17, further comprising receiving an instruction for an action to be taken responsive to the detection of motion in the region of interest.
